(19) United States
(12) Patent Application Publication
(10) Pub. No.: US 2025/0340285 A1
(43) Pub. Date: Nov. 6, 2025

(54) CAPTIVE BALLOON SUPPORT STRUCTURE ASSEMBLY

(71) Applicant: Werner MARTINSCHLEDDE, Rietberg (DE)

(72) Inventor: Werner MARTINSCHLEDDE, Rietberg (DE)

(21) Appl. No.: 19/270,900

(22) Filed: Jul. 16, 2025

Related U.S. Application Data
(63) Continuation of application No. PCT/DE2024/100032, filed on Jan. 15, 2024.

(30) Foreign Application Priority Data
Jan. 16, 2023 (DE) 10 2023 100 916.8

(51) Int. Cl. B64B 1/66; A01G 25/00; B64B 1/50; C25B 9/65; C25B 15/08; H02S 20/10

(52) U.S. Cl. CPC B64B 1/66; A01G 25/00; B64B 1/50; C25B 9/65; C25B 15/08; H02S 20/10

(57) ABSTRACT

A captive balloon support structure assembly comprising a captive balloon which is filled with a lifting gas having a lower density than the ambient air and is kept floating at a specific altitude above the ground. A three-dimensional wide-meshed supporting net that is tethered to the ground is placed over the captive balloon.

This nonprovisional application is a continuation of International Application No. PCT/DE2024/100032, which was filed on Jan. 15, 2024, and which claims priority to German Patent Application No. 10 2023 100 916.8, which was filed in Germany on Jan. 16, 2023, and which are both herein incorporated by reference.

### FIELD OF THE INVENTION

The present invention relates to a captive balloon support structure assembly comprising a captive balloon filled with a lifting gas, which has a lower density than ambient air, and held floating above a ground with a defined rising height.

### DESCRIPTION OF THE BACKGROUND ART

Conventional support structure assemblies, in particular for the roofing or shading of agricultural areas, for festivals and event tents and for the erection of canvases for open-air cinemas, generally consist of a support structure made of tubes, steel girders or wooden rods, which serve for spreading up and propping up a tarpaulin laid thereabove or a support net laid thereabove. Putting up these support structure assemblies is generally very labor-intensive and often requires a large number of helping persons. In particular when the covering to be erected is to have a great height with respect to the ground, putting up and dismantling these support structure assemblies or coverings requires a crane or the roping down of the helping persons, which is associated with a relatively high effort.

Captive balloon support structure assemblies for various application cases are known from the prior art.

FR 2 220 635 A1 and DE 201 15 809 U1 each disclose a captive balloon support structure assembly for spreading out a watertight roof.

JP H11 43098 A specifies a captive balloon support structure assembly for allowing a camera device to rise up.

DE 29 12 371 A1 discloses a gaming and sports apparatus for supporting the saltatorial force of a player or athlete.

GB 2 308 577 A discloses a tethered balloon with mooring guy lines.

GB 2 492 806 A discloses an essentially vertically upright captive balloon support structure assembly for spreading out a canvas.

From DE 20 2009 001323 U1 there is known a device with a balloon propped up by a supporting element standing on the ground for forming a tent or roof.

### SUMMARY OF THE INVENTION

It is therefore an object of the present invention to provide a captive balloon support structure assembly which can be used in a versatile manner and can be economically and easily disassembled/assembled for the irrigation of usable agricultural areas.

For achieving the object, the invention, in an example, provides a captive balloon support structure assembly that comprises a captive balloon filled with a lifting gas, which has a lower density than ambient air, and held floating above a ground with a defined rising height, as well as a coarse-meshed support net put over the captive balloon and fixed to the ground and spreading out space.

As the lifting gas there is preferably used a non-flammable noble gas and in particular helium. The lifting gas has a lower density than the ambient air and thereby imparts a buoyancy force to the captive balloon.

The particular advantage of the invention includes the fact that the captive balloon support structure assembly can be used in a variety of ways, has a structurally simple construction and can be quickly and easily put up and dismantled by a few helping persons. The captive balloon here erects the support net put over it and fixed or secured to the ground largely independently. In this way, even great heights with respect to the ground of 10 m or more can be covered without cranes and without working at great heights. The coarse-meshed support net advantageously offers a small wind-exposed surface and can here serve as a functional body, for example for covering, or serve as holding means for the fastening of further functional bodies, such as for example further two-dimensionally extended sheet-like structures.

Preferably, the coarse-meshed support net has a mesh width of a few centimeters and particularly preferably in the range of 3 cm to 20 cm, so that the support net is permeable to wind.

The support net can be spread out by a plurality of safety lines crossing one another above the captive balloon and fixed at the end to the ground. The safety lines impart additional mechanical stability to the captive balloon support structure assembly and predetermine the shape of the space formed between the ground and the support net erected by the captive balloon, in that they spread out the support net together with the captive balloon. In addition, the safety lines serve as hauling ropes which counteract a buoyancy force of the lifting-gas-filled captive balloon.

The captive balloon can be held on a mooring line fixed to the ground. The mooring line functions as a hauling rope which counteracts the buoyancy force of the captive balloon and holds it at the defined, adjustable rising height above the ground. The mooring line also holds the captive balloon, for example in the case of wind, essentially in its intended position above the ground. In addition, the captive balloon can be pulled in via the mooring line.

A balloon net can be arranged between the captive balloon and the support net. The balloon net is put around the captive balloon and encompasses it, the captive balloon being fastened to the mooring line via the balloon net. The balloon net is preferably configured with a coarse mesh width to be flexible or extensible in order to be able to follow a temperature-induced expansion of the captive balloon without being spread out too much or torn in the process. In the upper region of the captive balloon facing away from the ground, the balloon net is preferably connected or linked to the support net. A suitable material for the balloon net is, for example, a trailer net which is used for securing cargo. Such nets have a mesh width of 4 cm to 10 cm and are produced in particular from nylon, polyethylene or polypropylene.

An additional protective tarpaulin or a close-mesh protective net can be applied around the upper balloon region of the captive balloon, by means of which the captive balloon is protected against strong solar radiation, foreign objects flying around or birds. This prevents a bursting of the captive balloon as a result of strong solar radiation or damage to the balloon envelope of the captive balloon by impacts of foreign objects or flight of birds. The protective tarpaulin or the protective net is preferably encompassed by the balloon net or the support net or arranged thereunder.

The support net, the mooring line or the safety lines may each be fixed to the ground via at least one mass body arranged standing on the ground.

Preferably, a U-shaped bracket can be provided on the mass bodies. The mooring line and the safety lines can be knotted or deflected on the bracket.

The mass bodies can be produced from concrete. Mass bodies produced from concrete can be produced comparatively cost-effectively. It is here also possible that the bracket is cast into the concrete cost-effectively and without further connecting means.

The mass bodies can also be configured as containers and filled with a preferably liquid or pourable mass-imparting filling material, in particular water, sand, soil excavation or concrete. For example, a refillable waste container or a large container with a filling volume of 1 m³ can be provided as container.

A rotatably held deflection pulley for hauling in the mooring line or the safety lines can be provided on the bracket. The hauling in of the lines can hereby take place in a simplified manner, for example manually or via an additionally provided motor-driven cable winch.

The mass bodies assigned to the support net or the safety lines can be arranged in the shape of an arc of a circle and preferably equally spaced apart from one another radially in such a manner that a polygonal-pyramidal or approximately conical space is spread out between the ground and the safety lines or the support net.

The mooring line or the safety lines can be hauled in via a preferably motor-driven cable winch. The hauling in of the captive balloon or the dismantling of the captive balloon support structure assembly are hereby substantially simplified. It is conceivable that a plurality of safety lines can be hauled in simultaneously via one single cable winch or that, alternatively, a separate cable winch is assigned to the mooring line or to each safety line. The in any case partial hauling in of the mooring line reduces the rising height of the captive balloon and in this respect the overall height of the captive balloon support structure assembly according to the invention and can be provided, for example, for flight control at night.

A deflating unit, which can be arranged standing on the ground, can be provided for deflating the captive balloon, with an extraction device for extracting the lifting gas from a closable filling/deflating opening of the captive balloon and with a gas reservoir for receiving the extracted lifting gas. Advantageously, the normally expensive filling of lifting gas for the captive balloon can hereby be reused after the dismantling of the captive balloon support structure assembly and the captive balloon can be brought to a compact transport/storage volume.

A preferred rising height of the captive balloon can be at most 35 m. Up to this rising height, the captive balloon support structure assembly according to the invention can be operated, for example, in Germany without additional optical warning lights for flight control.

The captive balloon can be configured ellipsoidally and preferably spherically. It preferably has a radius in the range of 6 m to 6.5 m. In the case of a spherical captive balloon, this radius corresponds to a preferred filling volume of approximately 900 m³ to 1150 m³. This filling volume offers a sufficient buoyancy force for the captive balloon for many application cases, so that even large-area, heavy nets and functional bodies can be erected or carried by the captive balloon. Advantageously, large ground areas of a few thousand square meters can here be covered by the captive balloon support structure assembly.

Various developments of the captive balloon support structure assembly according to the invention for preferred applications are described below.

At least a fine-meshed shading net for shading usable agricultural areas can be held on the support net.

At least a collection net collecting condensation water can be held on the support net. Condensation water collected via the collection net can be discharged to the ground and gathered there, for example, via gathering gutters, gathering receptacles or the like. Usable agricultural areas, even in a comparatively dry climate, can additionally be irrigated in this manner.

The collection net can also serve for the direct irrigation of a ground area of the ground spanned by the support net, the collection net for this purpose preferably having a plurality of dripping threads via which the condensation water can drip directly onto the ground.

The collection net can be suspended in the support net and may extend vertically towards the ground or extends vertically towards the ground and is bent around a safety line.

At least a heat-insulating non-woven fabric cloth can be held on the support net.

At least a photovoltaic solar cell and preferably a photovoltaic thin-film solar cell or a dye-sensitized solar cell for generating electric current can be held on the support net. In this manner, the net area spread out by the support net can be used as a usable area for generating regeneratively generated photovoltaic current or the captive balloon support structure assembly according to the invention can be used as a solar park for generating photovoltaic current.

The photovoltaic solar cell can be configured as a photovoltaic thin-film solar cell. Thin-film solar cells or dye-sensitized solar cells can be configured as a bendably flexible solar module and, for example, sewn into or integrated into a textile fabric.

For storing or converting the photovoltaic current obtained in this manner, a corresponding current storage, for example, a battery or an accumulator, or an inverter can be provided.

The captive balloon support structure assembly according to the invention can comprise a water electrolysis unit preferably arranged standing on the ground for generating hydrogen. The water electrolysis unit is connected to the photovoltaic solar cell via an electric line or cable and utilizes the electric photovoltaic current generated by the photovoltaic solar cell for generating hydrogen by means of the electrolysis of water. The hydrogen generated in this manner can be used in a variety of ways as an energy carrier or, in principle and insofar as the legal regulations permit this, can be utilized as a lifting gas for filling the captive balloon. The captive balloon support structure assembly according to the invention can be operated in this manner in an energy-autonomous manner. The hydrogen generated is preferably stored or temporarily stored in a gas reservoir.

The water required for the electrolysis can preferably be collected and provided via the collection net collecting condensation water held on the support net and thus by the captive balloon support structure assembly itself.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a plan view of a captive balloon support structure assembly in an example,

FIG. 2 shows a side view of the captive balloon support structure assembly of FIG. 1,

FIG. 3 shows a side view of a captive balloon support structure assembly in an example according to the invention,

FIG. 4 shows a side view of a captive balloon support structure assembly in an example,

FIG. 5 shows an individual side view of an example of a mass body of a captive balloon support structure assembly according to the invention, and

FIG. 6 shows an individual side view of an example of a mass body of a captive balloon support structure assembly according to the invention.

### DETAILED DESCRIPTION

Various examples of a captive balloon support structure assembly 1 are illustrated in the Figures.

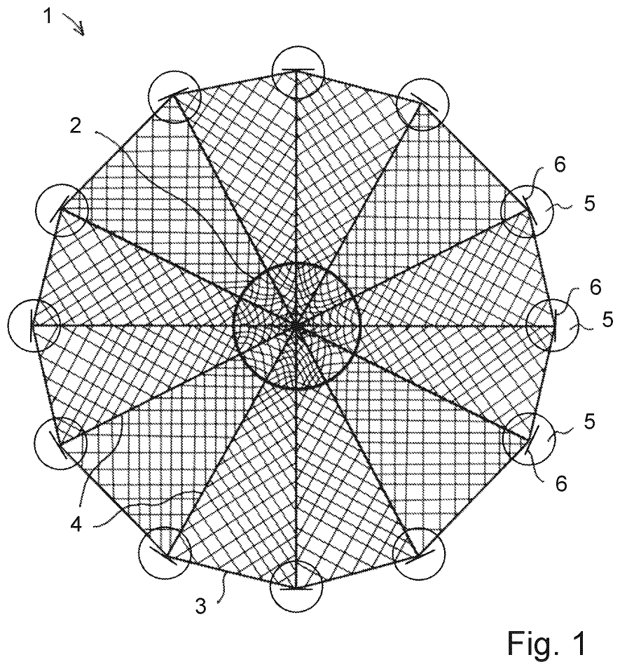

The captive balloon support structure assembly 1 of FIG. 1 has a captive balloon 2 filled with a lifting gas, over which a support net 3 is put. In addition, a total of six safety lines 4 of equal length are laid over the captive balloon 2 here, which cross one another above the captive balloon 2. As the plan view of the captive balloon support structure assembly 1 shown in FIG. 1 shows, the safety lines 4 are each configured of equal length here and are arranged equally spaced apart from one another radially, so that their ends all lie on an imaginary arc of a circle, in the circle center of which the captive balloon 2 is arranged. The safety lines 4 are each fixed at the end to mass bodies 5 arranged standing on the ground, which constitute counterweights to the raised captive balloon 2 and in this respect fix the captive balloon support structure assembly 1 to the ground 8.

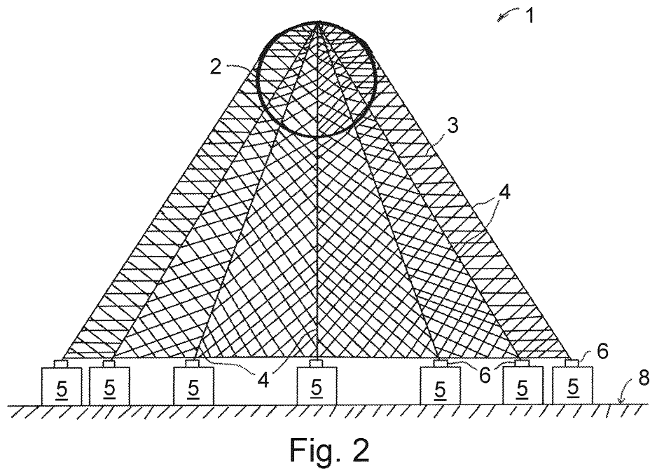

FIG. 2 shows the captive balloon support structure assembly 1 of FIG. 1 in a side view. The captive balloon 2 is held floating above the ground 8 with a defined rising height. As the lifting gas for the captive balloon 2 there is preferably used in this respect a noble gas and particularly preferably helium. Via the raised captive balloon 2 in this respect the support net 3 is erected vertically, the six safety lines 4 laid centrally over the captive balloon 2 spreading out the support net 3 here in the form of a uniform-polygonal pyramid with a twelve-cornered base area.

The support net 3 is configured to be comparatively coarse-meshed with a preferred mesh width of 5 cm to 20 cm. The support net 3 hereby offers a significantly reduced wind-exposed surface, which increases the stability of the captive balloon support structure assembly 1. In addition, the support net 3 can serve as a flexible holding or fastening element for further functional bodies.

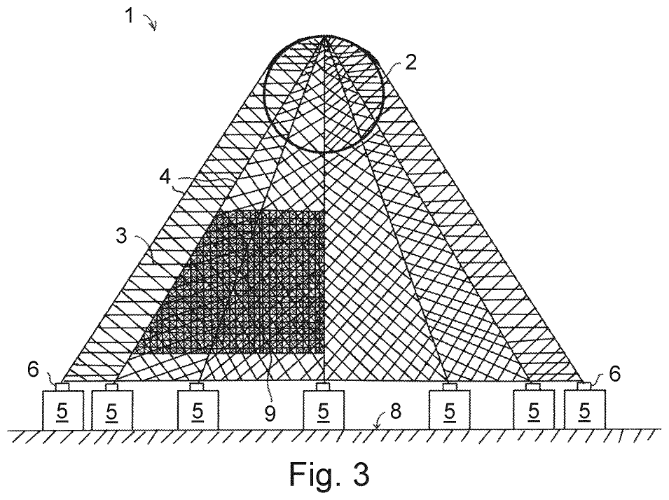

An example according to the invention of the captive balloon support structure assembly 1 is indicated in FIG. 3. In contrast to the example of FIG. 1, the captive balloon support structure assembly 1 here has, as an additional functional body, a collection net 9 for collecting condensation water, which collection net is held on the support net 3 and more fine-meshed compared to the latter. The collection net 9 can be fastened to the support net 3, for example, via carabiner hooks, cable ties, cords or the like.

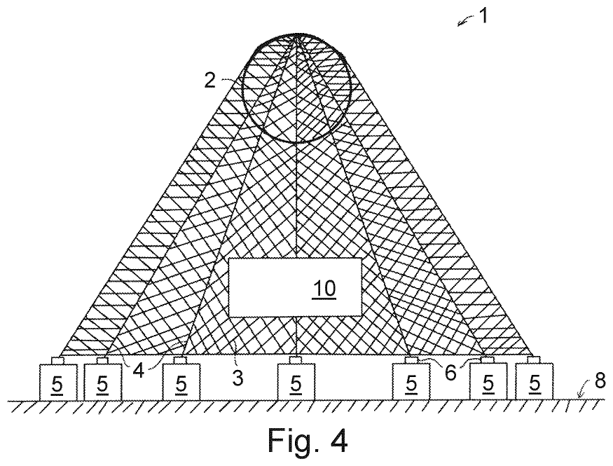

FIG. 4 illustrates an example of the captive balloon support structure assembly 1. In contrast to the example of FIG. 3 according to the invention, the captive balloon support structure assembly 1 here has, instead of the collection net 9, a canvas cloth 10 fastened to the support net 3. The canvas cloth 10 is produced from a fabric material which is permeable to wind and transparent, for example, a non-woven fabric material, and defines a canvas surface which can be irradiated by a light emitter, laser, projector or beamer or the like. The captive balloon support structure assembly 1 according to the invention can be used in this manner as an advertising medium or as an open-air cinema or the like.

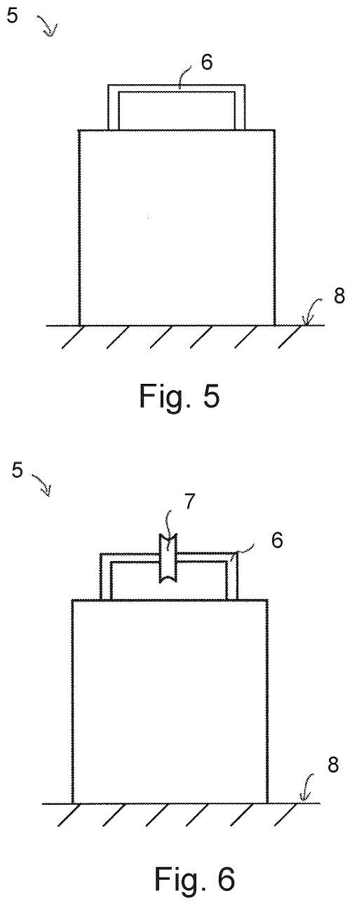

FIGS. 5 and 6 show various examples of the mass body 5 of the captive balloon support structure assembly 1 according to the invention.

The mass body 5 according to FIG. 5 corresponds to the mass body 5 of the captive balloon support structure assembly 1 of FIG. 3 according to the invention. It has a cylindrical shape and is preferably produced from concrete. On an upper side opposite the ground 8, a U-shaped bracket 6, which is preferably produced from stainless steel, is embedded in the cylindrical mass body 5. The bracket 6 serves for the fastening or the knotting of the safety lines 4. Likewise, the support net 3 can be fastened to the bracket 6, for example, via carabiner hooks, cords, cable ties or the like.

FIG. 6 shows the mass body 5 in an example. In addition to the example of FIG. 5, the mass body 5 here has a deflection pulley 7 rotatably mounted on the bracket 6. The deflection pulley 7 serves for the diversion of the safety lines 4 and in this respect simplifies the hauling in of the safety lines 4.

The invention is in no way restricted to the examples shown in the Figures. In particular, the components of the captive balloon support structure assembly 1 according to the invention are freely selectable within wide limits with regard to their shape, dimensioning, number and material selection.

For example, the shape of the captive balloon 2 can differ from the examples shown in the Figures and, for example, be cylindrical or cuboidal.

Furthermore, of course, the form of the support net 3 and the arrangement, number and length of the safety lines 4 can differ from one another from the examples shown in the Figures.

According to an example of the captive balloon support structure assembly 1 according to the invention, the support net 3 can be spread out on one side or in sections in an even or planar manner and vertically perpendicular to the ground 8, so that the canvas cloth 10 held thereon spreads out an even and vertical canvas surface.

According to a further example, the captive balloon support structure assembly 1 according to the invention has two or more captive balloons 2. It is hereby possible, for example, that the captive balloon support structure assembly 1 forms a tent-shaped space with a plurality of roof tips or tent bodies or roofing bodies which can be shaped almost as desired.

Likewise, the captive balloons 2 can have a different size or a large number of small captive balloons 2 can be provided with the advantage that these not at the installation site of the captive balloon support structure assembly 1, but can be transported there already filled. This also results in a redundancy, since in the case of the bursting of or damage to a captive balloon 2 the further captive balloons 2 remain filled and in this respect the buoyancy force required for the alignment of the captive balloon support structure assembly 1 can be maintained.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A captive balloon support structure assembly for an irrigation of usable agricultural areas, the assembly comprising:
a captive balloon filled with a lifting gas that has a lower density than ambient air, the captive ballon being held floating above a ground with a defined rising height;
a coarse-meshed support net fixed to a ground, the coarse-meshed support net being arranged over the captive ballon and being spreading out; and
at least one collection net to collect condensation water, the collection net being arranged on the coarse-meshed support net.

2. The captive balloon support structure assembly according to claim 1, wherein the condensation water collected via the collection net arranged on the support net is discharged to the ground and gathered there via gathering gutters and/or gathering receptacles.

3. The captive balloon support structure assembly according to claim 1, wherein the collection net held on the support net serves for the direct irrigation of a ground area of the ground spanned by the support net, wherein the collection net has a plurality of dripping threads via which the condensation water collected by the collection net drips directly onto the ground.

4. The captive balloon support structure assembly according to claim 1, wherein the support net is spread out by a plurality of safety lines crossing one another above the captive balloon and fixed at an end to the ground.

5. The captive balloon support structure assembly according to claim 1, wherein the captive balloon is held on a mooring line fixed to the ground.

6. The captive balloon support structure assembly according to claim 1, wherein the support net and/or the safety lines and/or the mooring line is/are each fixed to the ground via at least one mass body arranged on the ground.

7. The captive balloon support structure assembly according to claim 6, wherein at least two mass bodies are assigned to the support net and/or a safety line and are arranged in the shape of an arc of a circle and equally spaced apart from one another radially in such a manner that a polygonal-pyramidal and/or approximately conical space is spread out between the ground and the safety lines and/or the support net.

8. The captive balloon support structure assembly according to claim 6, wherein a U-shaped bracket and a deflection pulley, which is held rotatably on the bracket for hauling in the mooring line and/or the safety lines, are provided on the mass body.

9. The captive balloon support structure assembly according to claim 4, wherein the mooring line and/or the safety lines are hauled in via a motor-driven cable winch.

10. The captive balloon support structure assembly according to claim 1, wherein a deflator is arranged on the ground and is provided for deflating the captive balloon with an extraction device for extracting the lifting gas from a closable filling/deflating opening of the captive balloon and with a gas reservoir for receiving the extracted lifting gas.

11. The captive balloon support structure assembly according to claim 1, wherein a rising height of the captive balloon is at most 35 m and/or wherein the captive balloon is configured ellipsoidally and/or spherically and/or a radius of the captive balloon is between 6 m to 6.5 m.

12. The captive balloon support structure assembly according to claim 1, wherein at least a more fine-meshed shading net for shading usable agricultural areas is held on the support net.

13. The captive balloon support structure assembly according to claim 1, wherein at least a photovoltaic solar cell or a photovoltaic thin-film solar cell or a dye-sensitized solar cell is held on the support net.

14. The captive balloon support structure assembly according to claim 13, wherein a water electrolysis unit for generating hydrogen is provided, the water electrolysis unit being connected to the photovoltaic solar cell via an electric line and utilizing the electric photovoltaic current generated by the photovoltaic solar cell for generating hydrogen via the electrolysis of water, the water required for the electrolysis being collected and provided via the collection net.

15. The captive balloon support structure assembly according to claim 14, wherein the hydrogen generated by the water electrolysis unit is used as a lifting gas for filling the captive balloon, the hydrogen generated being temporarily stored in a gas reservoir.
